(19) United States
(12) Patent Application Publication
(10) Pub. No.: US 2023/0217395 A1
(43) Pub. Date: Jul. 6, 2023

(54) METHOD, TIME SYNCHRONIZATION METHOD, DEVICE, COMPUTER PROGRAM PRODUCT, AND STORAGE MEDIUM FOR AN UPLINK TRANSMISSION DELAY ESTIMATION

(71) Applicant: MITSUBISHI ELECTRIC CORPORATION, Tokyo (JP)

(72) Inventor: Damien CASTELAIN, Rennes Cedex 7 (FR)

(73) Assignee: MITSUBISHI ELECTRIC CORPORATION, Tokyo (JP)

(21) Appl. No.: 18/009,631

(22) PCT Filed: Apr. 23, 2021
(86) PCT No.: PCT/JP2021/017315

§ 371 Date: Dec. 9, 2022

(30) Foreign Application Priority Data
Jul. 10, 2020 (EP) 20185334.8

(51) Int. Cl. H04W 56/00; H04L 27/26

(52) U.S. Cl. CPC H04W 56/0045; H04L 27/265

(57) ABSTRACT

A method for an uplink transmission delay estimation between a user equipment and a base station in a wireless communication network is disclosed. At least one random access preamble is received by the base station. The cyclic prefix is first removed (S402), an N-FFT is applied (S404) and the obtained sequence in the frequency domain is multiplied (S406) with a complex conjugate of a corresponding transmitted preamble sequence to obtain for each subcarrier k, a sequence of values Zₖ. A set of sums S[s] is computed (S408) from Zₖ. C candidate values Γ[c] are calculated (S414), each being a weighted linear combination of (1) where l[c,s] is a phase correcting factor. The candidate Cₒₚₜ among the C candidates with a smallest associated error calculated with respect to the sums S[s] is selected. A phase is determined responsive to the selected candidate. A delay is determined (S420) responsive to the determined phase.

### TECHNICAL FIELD

At least one of the present embodiments generally relates to a method and a device for an uplink transmission delay estimation between a user equipment and a base station in a wireless communication network.

### BACKGROUND ART

In the last years, the demand for broadband high-speed, reliable and low latency services and applications, e.g. Internet Of Things devices, increased. Thus, new standards and technologies, known as 5G, have emerged to enable all these new services and applications.

For years, terrestrial and satellite networks have evolved almost independently from each other. The next generation of satellites will integrate with terrestrial 5G networks to manage connectivity to cars, vessels, airplanes and other IoT devices in remote and rural areas. 5G will encompass an evolution of today's 4G networks and the addition of a new, globally standardized radio-access technology known as “New Radio” (NR). Satellite communications will thus complement terrestrial 5G networks. To this aim, Low Earth Orbit Satellites (LEO) will play a key part in extending terrestrial 5G networks to remote areas not covered by small cell networks. In low earth orbits (LEO) satellites based mobile communication environments, the high-speed relative motion between the satellite and user equipment (UE) generates a large Doppler frequency shift. The large Doppler frequency shift is partly corrected at the UE side. However, it complicates the handling of the timing uncertainty at the base station side.

5G wireless communication system are based on orthogonal frequency-division multiplexing (OFDM). In an OFDM based system, orthogonal messages have to be sent, thus the major challenge in such a system is to maintain uplink orthogonality among users. Hence both frequency and time synchronization of the transmitted signals from the users are needed. A fine timing estimation has to be performed by the base station when the signals coming from users are detected. To this aim, it is known to use a Physical Random Access Channel (PRACH) method to obtain an initial fine time synchronization, which will allow to inform the user equipment (UE) how to compensate for the round trip delay. This compensation in the user equipment is also known as timing advance. After a successful random access procedure, in fact, the base station and the user equipment should be synchronized. In this way, the subsequent uplink signals could be correctly decoded and would not interfere with other users connected to the network.

PRACH method consists in the transmission of a set of random access preambles in order to allocate different resources to different users. A random access preamble comprises at least one cyclic prefix (CP) and Ns preamble sequences, Ns being an integer equal to or greater than 1.

Due to good zero autocorrelation and cross-correlation performance, Zadoff-Chu (ZC) sequence is generally used as the preamble sequence for timing synchronization in many systems. As an example, ZC sequences are used in current terrestrial 4G and 5G PRACH method.

FIG. 1 depicts a flowchart of a method used for time delay estimation according to the prior art.

At S300, a base station receives at least one random access preamble from a UE: y(t)=x(t)*h(t)+w(t), where x(t) is the transmitted random access preamble, h(t) is a transmission filter which includes equipment filters, neglected here, and a transmission delay τ and w(t) is an additive noise, mainly consisting of the thermal noise, and possibly of some interferences. The base station removes the CP(s) from the received random access preamble at S302 to obtain the Ns preamble sequences. It must be noted that this operation is approximate. Indeed, at this step the receiver of the base station has an imprecise knowledge of the time of arrival of the signal.

At S304, a N-FFT (Fast Fourier Transform) is applied on each of the Ns obtained preamble sequences to obtain Ns sequences in the frequency domain, N being the size of the FFT.

At S306, each obtained sequence in the frequency domain is multiplied by a complex conjugate of a corresponding transmitted preamble sequence. The multiplication by the complex conjugate of the transmitted preamble sequence corresponds to a convolution in the time domain. In practice, M subcarriers (M<N) are modulated for the constitution of the PRACH preamble. The other subcarriers are set to zero.

At S308, for each sequence, a N-IFFT is applied to come back in the time domain. In practice, the IFFT could be performed with a size of M, or any size between M and N, without a great impact on performance. Therefore, the result is an estimation of the transmission filter h(t) in the time domain. In a satellite context, in the absence of noise and impairments caused by the Doppler (frequency shift), this filter is roughly equivalent to a simple delay: h(t)=δ(t−τ), where δ is the Dirac pulse and τ is the transmission delay. In practice, h(t)=g(t−τ) where g(t) corresponds to all emission and reception filters, including the ones implied by the IFFT/FFT processes.

Finally, the delay can be estimated at step S310 by calculating the amplitude of each element of the estimated time response, and looking for the maximum value. The estimation in the time domain provides good results. However, the complexity is high because a N-IFFT is applied for each preamble sequence. The time latency of this method is also high which is an issue for time critical applications.

It is thus desirable to find a method for estimating a time delay that is precise and whose complexity and latency are limited.

### SUMMARY OF INVENTION

A method for an uplink transmission delay estimation between a user equipment and a base station in a wireless communication network is disclosed. The method being implemented in the base station comprises:
receiving at least one random access preamble transmitted by the user equipment, said random access preamble comprising at least one cyclic prefix and Ns preamble sequences occupying M subcarriers, M being an integer, Ns being an integer equal or greater than one;
removing the at least one cyclic prefix to obtain the Ns preamble sequences;
applying a Fast Fourier transform of size N on each of the Ns obtained preamble sequences to obtain Ns sequences in the frequency domain, N being an integer;
multiplying each obtained sequence in the frequency domain with a complex conjugate of a corresponding transmitted preamble sequence to obtain , for each obtained sequence in the frequency domain identified by an index p, M values Zₖ^{p} where k is an index identifying the subcarrier;

the method being characterized in that it further comprises:
computing the following sum for each value of s, where s is an integer lower than or equal to sₘₐₓ and corresponds to a subcarrier separation:

$$S [ s ] = \frac{1}{{N}_{s} ( M - s )} {\sum }_{p = 1}^{N s} {\sum }_{k = 1}^{M - s} {{Z}_{k + s}^{p} ( {Z}_{k}^{p} )}^{*}$$

calculating (S414) C candidate values Γ[c], wherein C is an integer and Γ[c] is a weighted linear combination of Γ[c,s] with weighting factors increasing with s and

$$Γ [ c , s ] = \sqrt[s]{S [ s ]} {e}^{\frac{- j 2 π l [ c , s ]}{s}} or Γ [ c , s ] = \sqrt[s]{{S}_{n o r m} [ s ]} {e}^{\frac{- j 2 π l [ c , s ]}{s}}$$

where l[c,s] is a phase correcting factor and Sₙₒᵣₘ[s] is a normalized version of S[s];
selecting a candidate Cₒₚₜ among the C candidate values Γ[c] with a smallest associated error calculated with respect to the sums S[s];
determining a phase responsive to the selected candidate; and
determining a delay responsive to the determined phase.
   This method whose complexity and latency is limited makes it possible to precisely estimate the time delay. The method is also performant in case of noise and distortions, e.g. in case of high Doppler.

In an embodiment, determining the delay responsive to the determined phase comprises calculating the delay \hat{τ} as follows:

$$\hat{τ} = \frac{N {φ}_{o p t}}{2 π}$$

where φₒₚₜ is the determined phase.

In an embodiment, determining the phase responsive to the selected candidate comprises calculating the phase φₒₚₜ as follows:

φₒₚₜ=−arg Γ[cₒₚₜ].

where Cₒₚₜ is the selected candidate, arg(x) an operator returning the argument of x.

In an embodiment, selecting the candidate Cₒₚₜ among the C candidates with a smallest associated error calculated with respect to the sums S[s] is determined as follows:

$${C}_{o p t} = {arg min}_{c} {\sum }_{s} {\vert {S}_{n o r m} [ s ] - {Γ}^{s} [ c ] \vert}^{2}$$

where Sₙₒᵣₘ[s] is a normalized version of S[s].

In an embodiment, the wireless communication network is a 5G network.

In an embodiment, each obtained sequence in the frequency domain is a Zadoff-Chu sequence or a M-sequence.

In an embodiment, Ns is equal to 1 or 2. In an embodiment, M is equal to 839.

A time synchronization method between a user equipment and a base station is also disclosed. The time synchronization method comprises:
estimating, by the base station, a transmission delay using the method for an uplink transmission delay estimation according to one of the previous embodiments;
transmitting, by the base station, the estimated transmission delay to the user equipment;
applying, by the user equipment, a time delay responsive to the received estimated transmission delay on all the uplink communications transmitted to the base station.

A device of the base station type in communication with a user equipment in a wireless communication network is further disclosed. The device is configured to estimate an uplink transmission delay estimation from the user equipment, the device comprising:
means for receiving at least one random access preamble transmitted by the user equipment, said random access preamble comprising at least one cyclic prefix and Ns preamble sequences occupying M subcarriers, M being an integer, Ns being an integer equal or greater than one;
means for removing the at least one cyclic prefix to obtain the Ns preamble sequences;
means for applying a Fast Fourier transform of size N on each of the Ns obtained preamble sequences to obtain Ns sequences in the frequency domain, N being an integer;
means for multiplying each obtained sequence in the frequency domain with a complex conjugate of a corresponding transmitted preamble sequence to obtain, for each obtained sequence in the frequency domain identified by an index p, M values Zₖ^{p} where k is an index identifying the subcarrier;

the method being characterized in that it further comprises:
means for computing the following sum for each value of s, where s is an integer lower than or equal to sₘₐₓ and corresponds to a subcarrier separation:

$$S [ s ] = \frac{1}{{N}_{s} ( M - s )} {\sum }_{p = 1}^{N s} {\sum }_{k = 1}^{M - s} {{Z}_{k + s}^{p} ( {Z}_{k}^{p} )}^{*}$$

means for calculating C candidate values Γ[c], wherein C is an integer and Γ[c] is a weighted linear combination of Γ[c,s] with weighting factors increasing with s and

$$Γ [ c , s ] = \sqrt[s]{S [ s ]} {e}^{\frac{- j 2 π l [ c , s ]}{s}} or Γ [ c , s ] = \sqrt[s]{{S}_{n o r m} [ s ]} {e}^{\frac{- j 2 π l [ c , s ]}{s}}$$

where l[c,s] is a phase correcting factor and Sₙₒᵣₘ[s] is a normalized version of S[s];
means for selecting a candidate Cₒₚₜ among the C candidate values Γ[c] with a smallest associated error calculated with respect to the sums S[s];
means for determining a phase responsive to the selected candidate; and
means for determining a delay responsive to the determined phase.

A computer program product is disclosed. It comprises program code instructions that can be loaded in a programmable device, the program code instructions causing implementation of the method according to one the previous embodiments when the program code instructions are run by the programmable device.

A storage medium, possibly non-transitory, is disclosed. It stores a computer program comprising program code instructions, the program code instructions causing implementation of the method according to one the previous embodiments when the program code instructions are read from the storage medium and run by the programmable device.

### BRIEF DESCRIPTION OF DRAWINGS

The characteristics of the invention will emerge more clearly from a reading of the following description of at least one example of embodiment, said description being produced with reference to the accompanying drawings.

FIG. 1 depicts a flowchart of a method for delay estimation according to the prior art.

FIG. 2 depicts a system in which various embodiments may be implemented.

FIG. 3 illustrates the principles of random access method in which various embodiments may be implemented.

FIG. 4 depicts a flowchart of a method for delay estimation according to a specific embodiment.

FIG. 5 depicts a flowchart of a method for determining phase correcting factors according to a specific embodiment.

FIG. 6 illustrates schematically an example of hardware architecture of a device according to a specific embodiment.

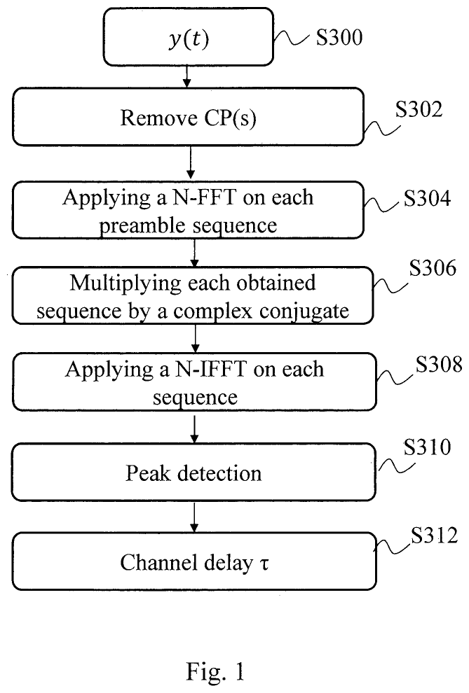

### DESCRIPTION OF EMBODIMENTS

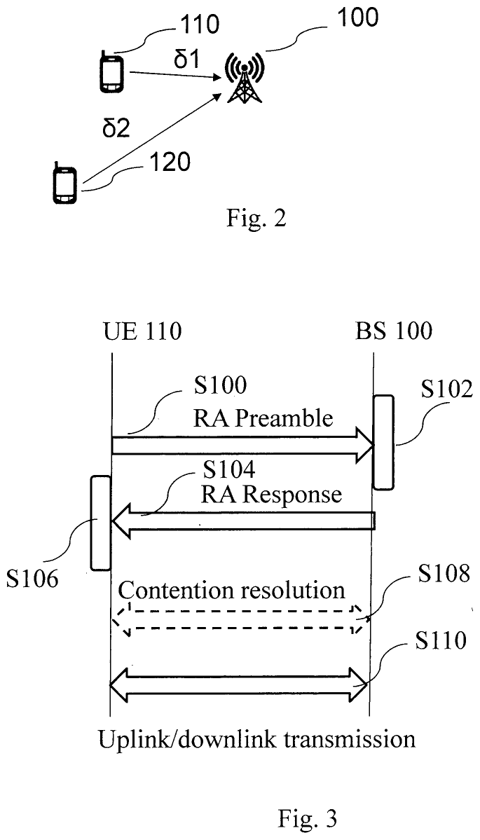

FIG. 2 depicts a system in which various embodiments may be implemented. Two user equipments 110 and 120, such as for example cell phones or tablets, are connected to a base station 100. The base station 100 is for example a 5G base station which uses New Radio (NR) technology and is also referred to as a gNodeB (gNb). The base station may also be a 3G or a 4G base station.

The transmission time between the first user equipment 110 and the base station 100 is equal to δ1 and the transmission time between the second user equipment 120 and the base station 100 is equal to δ2. These values need to be estimated in order to synchronize the base station with these equipments and thus avoid interference with other UEs connected to the network. Indeed, the UEs have different transmission delays to the base station, and, therefore, a method to compensate for these differences is required so as to prevent that data transmitted from these different UEs to collide at the base station 100.

To this aim, a random access method may be used such as the one disclosed with respect to FIG. 3. The principles disclosed herein in the context of a base station may apply to any receiver that needs to estimate a delay.

FIG. 3 illustrates the principles of random access method in which various embodiments may be implemented. Random access is generally performed when the UE powers-on or turns-on from sleep mode or during the handoff from one cell to another or when it loses uplink timing synchronization.

At S100, the user equipment 110 transmits in an uplink a Random Access (RA) preamble to the base station 100. The RA preamble is randomly selected. The RA preamble comprises at least one cyclic prefix (CP) and at least one preamble sequence, e.g. a ZC sequence. However, the present principles are not limited to this specific RA preamble. In particular, sequences other than ZC sequences may be used such as M-sequences.

At S102, the base station estimates a delay, e.g. a round trip transmission delay. In another embodiment, the base station estimates a time difference between an average transmission delay known by the base station and the current transmission delay. From the average transmission delay and the time difference the base station can estimate the exact transmission delay. In an embodiment, the base station knows its distance from the center of the cell to which the user equipment belongs. From this distance, the base station can estimate the average transmission delay.

In another embodiment, the base station estimates a time difference between a previously estimated transmission delay and the current transmission delay. From the previously estimated transmission delay and the time difference the base station can estimate the current transmission delay. Indeed, after the UE has become synchronized, the synchronization may be lost. This can, for example, be the case if the transmission delay changes because for example the UE moves further from or closer to the base station. Therefore, a time difference may be estimated between the previous transmission delay corresponding to the former position of the UE with respect to the base station and the current one corresponding for example to the new position of the UE. The base station may also move which is the case with a LEO satellite. Knowing its displacement, the base station can estimate at least partially the effect of its displacement on the delay and thus determine a time correction to be applied. However, this time correction depends on the user equipment position and is thus not perfect.

At S104, the base station 100 transmits in a downlink a RA response to the user equipment 110. The RA response comprises the value of the transmission delay estimated by the base station. In one embodiment, the RA response indicates the successfully received preamble(s) along with the timing advance (TA) value and uplink resource allocation information to the UE. The timing advance (TA) value corresponds to the estimated transmission delay.

At S106, the UE uses the TA value to adjust its uplink timing. More precisely, the UE utilizes the received TA value to determine a suitable transmit timing.

At S108, an optional contention resolution step may apply. Indeed, the randomly selected RA preamble does not enable unique identification of the UE. Therefore, multiple UEs may try a random access with the same RA preamble sequence on the same RA channel. The contention resolution step S108 helps uniquely identify the UE that has been selected.

At S110, the user equipment 110 and the base station 100 may exchange data.

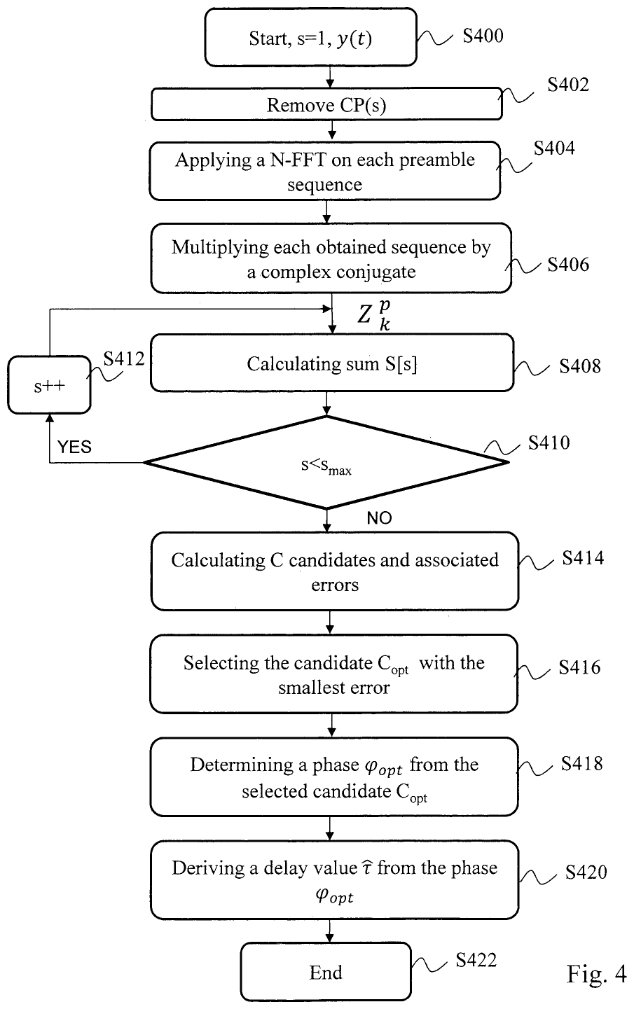

FIG. 4 depicts a flowchart of a method for delay estimation according to a specific embodiment.

The method starts at S400. An integer s is set to the value 1. The base station 100 receives at least one random access preamble from a UE 110: y(t)=x(t)*g(t−τ)+w(t). The random access preamble comprises at least one cyclic prefix CP and Ns preamble sequences occupying M subcarriers, M being an integer and Ns being an integer equal or greater than one. In one embodiment, the received random access sequence comprises a single cyclic prefix CP followed by Ns preamble sequences. In a variant, the received random access sequence comprises Ns cyclic prefixes CPs, each CP being followed by a single preamble sequence.

The received random access sequence may comprise additional data.

At S402, the base station 100 removes the at least one CP . In one embodiment, the base station 100 removes the single cyclic prefix CP. In a variant, the base station removes the Ns cyclic prefixes. Thus, Ns preamble sequences, constituted by N samples in the time domain, occupying M subcarriers are obtained. Each one of the Ns preamble sequences is an OFDM block. Indeed, each one of the Ns preamble sequences in the time domain corresponds to a counterpart preamble sequence in the frequency domain. Said otherwise, the Ns time domain preamble sequences received by the base station were obtained, on the transmitter side, from counterpart preamble sequences in the frequency domain by applying a N-FFT (OFDM modulation). The difference N-M corresponds to N-M non-modulated subcarriers, i.e. to zero values at the input of the N-FFT.

At S404, a N-FFT, i.e. a Fast Fourier Transform of size N, is applied on each of the Ns obtained preamble sequences to obtain Ns sequences in the frequency domain, e.g. ZC sequences or M-sequences. Each sequence in the frequency domain is identified by an index p varying from 1 to Ns. N is equal or proportional to a nominal value N′ defined by the standard corresponding to the sent sequence (4G, 5G . . . ). At S406, in the frequency domain, each obtained sequence in the frequency domain, identified by an index p, is multiplied by a complex conjugate of a corresponding transmitted preamble sequence. Thus, for each obtained sequence in the frequency domain of index p, M values Zₖ^{p} are obtained where k is an index identifying the subcarriers, k thus varying from 1 to M.

In the frequency domain, with a delay τ, after multiplication by the conjugate and omitting the noise and interference due to Doppler, Zₖ^{p} is obtained for the subcarrier k: Zₖ^{p}=e^{-j2πkτ/N}. The phase of the obtained sequence Zₖ^{p} in the frequency domain is thus representative of the transmission delay which is to be estimated.

At S408, a sum S[s] is calculated as follows from the values Zₖ^{p} and its conjugate(Zₖ^{p})*:

$$S [ s ] = \frac{1}{{N}_{s} ( M - s )} {\sum }_{p = 1}^{N s} {\sum }_{k = 1}^{M - s} {Z}_{k + s}^{p} + {( {Z}_{k}^{p} )}^{*} = {e}^{- 2 π s τ / N} + {η}_{s} = {ρ}_{s} \qquad ( Eq . 1 )$$

where M is the number of subcarriers occupied by the sequence (839 in 4G and 5G), the index s refers to a specific carrier separation, known as “the step” between the subcarriers involved in the sum calculation and the variable ηₛ corresponds to the noise plus interference for example caused by Doppler. ρₛ is equal to the amplitude of S[s]. Said otherwise, Sₙₒᵣₘ[s]= [symbol] , where Sₙₒᵣₘ[s] is a normalized version of S[s]. Each sum S [s] after normalization is thus an estimate of [symbol] .

Thus, each sum corresponds to an average of a differential demodulation in the frequency domain.

At S410, the value of s is compared with sₘₐₓ. If s<sₘₐₓ, the method continues at S412 and s is increased by 1. Otherwise, the method continues at S414. Thus at S414, K sums S[s] are obtained with sϵ[1; sₘₐₓ]. From each sum S[s], a phase \hat{φ}ₛ may be estimated, wherein the phase \hat{φ}ₛ is a multiple of the delay τ. However, each phase \hat{φ}ₛ presents a phase ambiguity of

$$\frac{2 π}{s} ,$$

which limits the delay range if only an estimation from S[s] is performed with s>1. Indeed, if

$$ψ = \frac{2 π τ}{N}$$

represents the real phase to be estimated, the estimation \hat{φ}ₛ corresponds to

\hat{φ}ₛ=sψ+noise (Eq. 2)

In the general case, for a given step s, an estimation \hat{φ}ₛ corresponds to a set of s values:

$$\{ {\hat{φ}}_{s} , {\hat{φ}}_{s} + \frac{2 π}{s} , … , {\hat{φ}}_{s} + \frac{2 π ( s - 1 )}{s} \} = \{ {\hat{φ}}_{s} + l \frac{2 π}{s} , l = 0 to ( s - 1 ) \}$$

Thus, from one estimation \hat{φ}ₛ obtained from a single sum S[s], it is not possible to know the real phase ψ in the case where s is different of 1. There is thus an ambiguity.

To resolve these ambiguities, the different estimations of the phase are combined in step S414 in order to get a unique estimate of the phase and thus of the delay.

At S414, for a given set of steps s, C candidate sets are calculated from the sums S[s]. A given candidate set is composed of L (which is equal to the number of steps) estimations of ψ, each such estimations corresponding to a particular value of

$$l = l [ c , s ] : \hat{ψ} [ c , s ] = {φ}_{s} + l [ c , s ] \frac{2 π}{s} .$$

l=l[c,s] is a phase correcting factor that depends on the step s and on the candidate c. l[c, s] is an integer. This phase correcting factor is used to cope with the inherent phase ambiguity

$$\frac{2 π}{s} .$$

For example, if s∈{1,2,3,4}, i.e. sₘₐₓ=4, C=6 candidate sets are calculated as indicated in the table 1.

TABLE 1
candidate sets for steps s = {1, 2, 3, 4}

| Index c | l[c, s] |
|---|---|
| 1 | (0, 0, 0, 0) |
| 2 | (0, 0, 0, 1) |
| 3 | (0, 0, 1, 1) |
| 4 | (0, 1, 1, 2) |
| 5 | (0, 1, 2, 2) |
| 6 | (0, 1, 2, 3) |

For example, if c=4, the L=4 estimations of \hat{ψ}[4, s] correspond to

$$\{ {φ}_{1} , {φ}_{2} + π , {φ}_{3} + \frac{2 π}{3} , {φ}_{4} + π \} .$$

For each candidate set, the L estimations are combined into one. It could be possible to directly combine these phases \hat{ψ}[c, s]. However, it would have the disadvantage that the corresponding noise will no longer be Gaussian. In particular, this would make more problematic to select the best combination with a least square criterion.

Therefore, the base station 100 combines the

$$Γ [ c , s ] = {e}^{- j \hat{ψ} [ c , s ]} = {e}^{- j {φ}_{s}} {e}^{- j l [ c , s ] \frac{2 π}{s}} = \sqrt[s]{S [ s ]} {e}^{- j \frac{2 π l [ c , s ]}{s}}$$

instead of the

$$\hat{ψ} [ c , s ] = {φ}_{s} + l [ c , s ] \frac{2 π}{s} .$$

In the above calculation, the normalized version of S[s] may be used. In this latter case,

$$Γ [ c , s ] = \sqrt[s]{{S}_{n o r m} [ s ]} {e}^{\frac{- j 2 π l [ c , s ]}{s}} .$$

The normalized version Sₙₒᵣₘ[s] of S[s] is obtained by dividing S[s] by its amplitude in order to obtain a complex number of amplitude 1. Instead of directly adding the different Γ[c, s] in order to get a simple estimate Γ[c] for each candidate set c, a sum weighted by W[s] is used. Thus, Γ[c] for each candidate set c is calculated as follows:

$$Γ [ c ] = \frac{1}{{\sum }_{s} W [ s ]} {\sum }_{s} W [ s ] Γ [ c , s ] = \frac{1}{{\sum }_{s} W [ s ]} {\sum }_{s} W [ s ] \sqrt[s]{S [ s ]} {e}^{- j 2 π \frac{l [ c , s ]}{s}}$$

Therefore, for each candidate (c=1 to 6 in the previous example), Γ[c] corresponds to a linear combination of the

$${S [ s ]}^{1 / s} = \sqrt[s]{S [ s ]} .$$

W[s] is a weighting factor that depends on s and increases with s. The weights W[s] may take the following values according to various embodiments: W[s]=s², W[s]=s², W[s]=1.

At the end of S414, C estimated values Γ[c] are obtained. The base station 100 has to select the most reliable estimation among the C estimations Γ[c]. To this aim, a least square criterion may be used, taking benefit that the noise/interference is still Gaussian or almost Gaussian.

According to equations (1) and (2), S[s] is an estimate of e^{-jsψ}. Besides, each Γ[c] is an estimate of e^{-jψ}. Therefore, for each candidate c, the base station calculates the following square error:

Error[c]=Σₛ|Sₙₒᵣₘ[s]−Γ^{s}[c]|² where Γ^{s}[c] means Γ[c] raised to the power of s.

At S416, the base station 100 selects a best candidate Cₒₚₜ as the one minimizing Error[c]. Minimizing the square error is equivalent to maximizing the reliability of the estimation under the Gaussian assumption.

At S418, a phase φₒₚₜ is determined from the selected best candidate Cₒₚₜ as follows: φₒₚₜ=−arg Γ[cₒₚₜ].

At S420, the base station 100 estimates the corresponding delay \hat{τ} from the determined phase φₒₚₜ as follows:

$$\hat{τ} = \frac{N {φ}_{opt}}{2 π} .$$

The method ends at S422.

Each combination Γ[c] corresponds to a different way to resolve the different phase ambiguities. The reliability, i.e. Error[c], of each combination Γ[c] is evaluated with respect to the observations, i.e. the original sums S[s]. The combination with the best reliability, i.e. the lowest Error[c], is selected in order to provide the final delay estimation. By combining the different estimations, the phase ambiguity is thus resolved and thus a unique estimate of the phase and therefore of the delay is obtained. The method may be used in a 5G satellite system and works with very large Doppler. Thus, the method makes it possible to estimate the delay despite the difficulty caused by Doppler and by the low SNR inherent to satellite transmission.

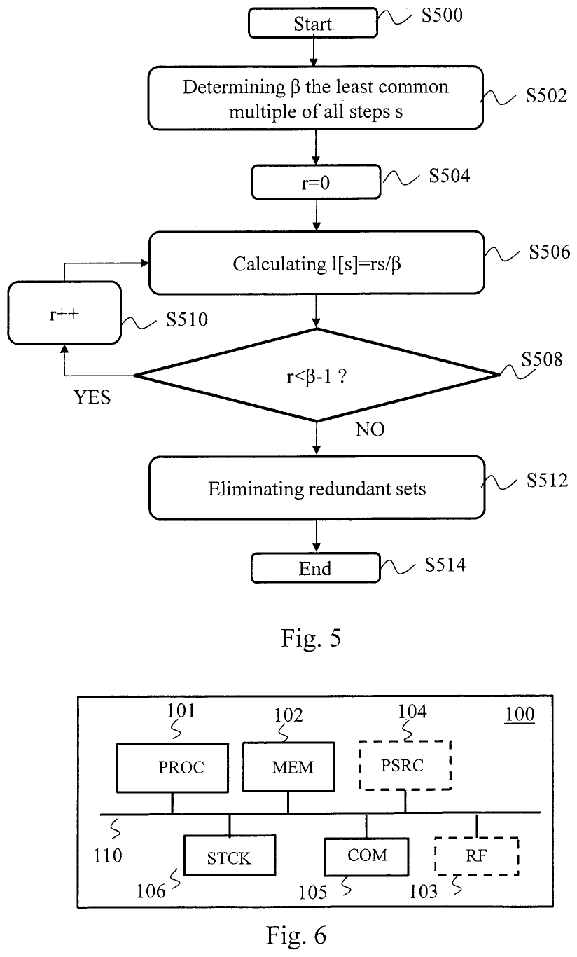

FIG. 5 depicts a flowchart of a method for determining the phase correcting factors l[s;c] according to a specific embodiment.

The method starts at step S500. An integer r is set to the value 0.

At S502, the Least Common Multiple (LCM) β of all the steps s is determined. In the case where the steps are equal to the followings values {1, 2, 3, 4}, β=12. The phase range [0; 2π] is divided into β intervals of size

$$\frac{2 π}{β} .$$

At S506, a phase correcting factor corresponding to a step s in calculated as follows:

$$l [ s ] = \frac{r s}{β}$$

for the interval

$$[ r \frac{2 π}{β} ; ( r + 1 ) \frac{2 π}{β} ] .$$

For the calculation of l[s] the division by β is an integer division.

At S508, r is compared with β−1. If r<β−1, the method continues at S510 and r is increased by one. Otherwise the method continues at S512.

At step S512, the redundant sets are eliminated. At the end each set l[c,s] is unique.

In the above example (for steps sϵ{1, 2, 3, 4} and β=12), the sets of correcting factors are defined as follows before elimination of redundant sets:

TABLE 2

| r | $l [ s ] = \frac{r s}{β}$ |
|---|---|
| 0 | (0, 0, 0, 0) |
| 1 | (0, 0, 0, 0) |
| 2 | (0, 0, 0, 0) |
| 3 | (0, 0, 0, 1) |
| 4 | (0, 0, 1, 1) |
| .5 | (0, 0, 1, 1) |
| 6 | (0, 1, 1, 2) |
| 7 | (0, 1, 1, 2) |
| 8 | (0, 1, 2, 2) |
| 9 | (0, 1, 2, 3) |
| 10 | (0, 1, 2, 3) |
| 11 | (0, 1, 2, 3) |

There are 6 redundant sets underlined in the above table 2. After elimination of the redundant sets, 6 candidate sets remains as defined in the table 1.

In one embodiment, this method is performed off-line. The phase correcting factors l[s;c] determined off-line may thus be stored in memory for further use by a receiver. Assuming the step s varies from 1 to sₘₐₓ, the number of candidate sets is provided in Table 2.

TABLE 3
Number C of candidates sets

| sₘₐₓ | C |
|---|---|
| 1 | 1 |
| 2 | 2 |
| 3 | 4 |
| 4 | 6 |
| 5 | 10 |
| 6 | 12 |
| 7 | 18 |
| 8 | 22 |

In a specific embodiment, the receiver of the base station chooses the sₘₐₓ value, and thus retrieves the stored phase correcting factors l[s;c] from memory. In a variant, the receiver may compute the phase correcting factors l[s;c] using the above method.

FIG. 6 depicts a flowchart of a device such as a base station 100 configured to estimate a time delay according to a specific embodiment.

The device 100 comprises, connected by a communication bus 110: a processor or CPU (acronym of “Central Processing Unit”) 101; a random access memory RAM 102; a read only memory ROM 103; a storage unit or a storage medium reader such as an SD (acronym of “Secure Digital”) card reader 104 or a HDD (acronym of “Hard Disk Drive”); and at least one set of communication interfaces COM 105 enabling the device 100 to transmit and receive data.

The processor 101 is capable of executing instructions loaded into the RAM 102 from the ROM 103, from an external memory (such as an SD card), from a storage medium (such as the HDD), or from a communication network. When the device 100 is powered up, the processor 101 is capable of reading instructions from the RAM 102 and executing them. These instructions form a computer program causing the implementation, by the processor 101, of the method described in relation to FIG. 4.

The methods described in relation to FIGS. 4 may be implemented in software form by the execution of the set of instructions by a programmable machine, for example a DSP (acronym of “Digital Signal Processor”), a microcontroller or a GPU (acronym of “Graphics Processing Unit”), or be implemented in hardware form by a machine or a dedicated component (chip or chipset), for example an FPGA (acronym of “Field-Programmable Gate Array”) or an ASIC (acronym of “Application-Specific Integrated Circuit”). In general, the device 100 includes electronic circuitry adapted and configured for implementing the methods described in relation to FIG. 4.

1. A method for an uplink transmission delay estimation between a user equipment and a base station in a wireless communication network, the method being implemented in the base station and comprising:
receiving at least one random access preamble transmitted by the user equipment, said random access preamble comprising at least one cyclic prefix and Ns preamble sequences occupying M subcarriers, M being an integer, Ns being an integer equal or greater than one;
removing the at least one cyclic prefix to obtain the Ns preamble sequences;
applying a Fast Fourier transform of size N on each of the Ns obtained preamble sequences to obtain Ns sequences in the frequency domain, N being an integer;
multiplying each obtained sequence in the frequency domain with a complex conjugate of a corresponding transmitted preamble sequence to obtain , for each obtained sequence in the frequency domain identified by an index p, M values Zₖ^{p} where k is an index identifying the subcarrier;
the method being characterized in that it further comprises:
computing the following sum for each value of s, where s is an integer lower than or equal to sₘₐₓ and corresponds to a subcarrier separation:
$$S [ s ] = \frac{1}{{N}_{s} ( M - s )} {\sum }_{p = 1}^{Ns} {\sum }_{k = 1}^{M - s} {{Z}_{k + s}^{p} ( {Z}_{k}^{p} )}^{*}$$
calculating C candidate values Γ[c], wherein C is an integer and Γ[c] is a weighted linear combination of Γ[c,s] with weighting factors increasing with s and
$$Γ [ c , s ] = \sqrt[s]{S [ s ]} {e}^{\frac{- j 2 π l [ c , s ]}{s}} or Γ [ c , s ] = \sqrt[s]{{S}_{norm} [ s ]} {e}^{\frac{- j 2 π l [ c , s ]}{s}}$$
where l[c,s] is a phase correcting factor and Sₙₒᵣₘ[s] is a normalized version of S[s];
selecting a candidate Cₒₚₜ among the C candidate values Γ[c] with a smallest associated error calculated with respect to the sums S[s];
determining a phase responsive to the selected candidate; and
determining a delay responsive to the determined phase.

2. The method according to claim 1, wherein determining the delay responsive to the determined phase comprises calculating the delay \hat{τ} as follows:
$$\hat{τ} = \frac{N {φ}_{opt}}{2 π}$$
where φₒₚₜ is the determined phase.

3. The method according to claim 1, wherein determining the phase responsive to the selected candidate comprises calculating the phase φₒₚₜ as follows:
φₒₚₜ=−arg Γ[cₒₚₜ]
where Cₒₚₜ is the selected candidate, arg(x) an operator returning the argument of x.

4. The method according to claim 1, wherein selecting the candidate Cₒₚₜ among the C candidates with a smallest associated error calculated with respect to the sums S[s] is determined as follows:
$${C}_{opt} = {argmin}_{c} {\sum }_{s} {\vert {S}_{norm} [ s ] - {Γ}^{s} [ c ] \vert}^{2}$$
where Sₙₒᵣₘ[s] is a normalized version of S[s].

5. The method according to claim 1, wherein the wireless communication network is a 5G network.

6. The method according to claim 1, wherein each obtained sequence in the frequency domain is a Zadoff-Chu sequence or a M-sequence.

7. The method according to claim 1, wherein Ns is equal to 1 or 2.

8. The method according to claim 1, wherein M is equal to 839.

9. A time synchronization method between a user equipment and a base station comprising:
estimating, by the base station, a transmission delay according to claim 1;
transmitting, by the base station, the estimated transmission delay to the user equipment;
applying, by the user equipment, a time delay responsive to the received estimated transmission delay on all the uplink communications transmitted to the base station.

10. A device of the base station type in communication with a user equipment in a wireless communication network, the device being configured to estimate an uplink transmission delay estimation from the user equipment, the device comprising:
means for receiving at least one random access preamble transmitted by the user equipment, said random access preamble comprising at least one cyclic prefix and Ns preamble sequences occupying M subcarriers, M being an integer, Ns being an integer equal or greater than one;
means for removing the at least one cyclic prefix to obtain the Ns preamble sequences;
means for applying a Fast Fourier transform of size N on each of the Ns obtained preamble sequences to obtain Ns sequences in the frequency domain, N being an integer;
means for multiplying each obtained sequence in the frequency domain with a complex conjugate of a corresponding transmitted preamble sequence to obtain, for each obtained sequence in the frequency domain identified by an index p, M values Zₖ^{p} where k is an index identifying the subcarrier;
the method being characterized in that it further comprises:
means for computing the following sum for each value of s, where s is an integer lower than or equal to sₘₐₓ and corresponds to a subcarrier separation:
$$S [ s ] = \frac{1}{{N}_{s} ( M - s )} {\sum }_{p = 1}^{Ns} {\sum }_{k = 1}^{M - s} {{Z}_{k + s}^{p} ( {Z}_{k}^{p} )}^{*}$$
means for calculating C candidate values Γ[c], wherein C is an integer and Γ[c] is a weighted linear combination of Γ[c,s] with weighting factors increasing with s and
$$Γ [ c , s ] = \sqrt[s]{S [ s ]} {e}^{\frac{- j 2 π l [ c , s ]}{s}} or Γ [ c , s ] = \sqrt[s]{{S}_{norm} [ s ]} {e}^{\frac{- j 2 π l [ c , s ]}{s}}$$
where l[c,s] is a phase correcting factor and Sₙₒᵣₘ[s] is a normalized version of S[s];
means for selecting a candidate Cₒₚₜ among the C candidate values Γ[c] with a smallest associated error calculated with respect to the sums S[s];
means for determining a phase responsive to the selected candidate; and
means for determining a delay responsive to the determined phase.

11. A computer program product comprising program code instructions that can be loaded in a programmable device, the program code instructions causing implementation of the method according to claim 1 when the program code instructions are run by the programmable device.

12. A storage medium storing a computer program comprising program code instructions, the program code instructions causing implementation of the method according to claim 1 when the program code instructions are read from the storage medium and run by the programmable device.
